(19) United States
(12) Patent Application Publication
(10) Pub. No.: US 2019/0323660 A1
(43) Pub. Date: Oct. 24, 2019

(54) STORAGE TANK FOR CRYOGENIC LIQUID

(71) Applicant: John G. Brothers, Washington Twp., MI (US)

(72) Inventor: John G. Brothers, Washington Twp., MI (US)

(21) Appl. No.: 15/959,494

(22) Filed: Apr. 23, 2018

(51) Int. Cl. F17C 5/02; F17C 13/00

(52) U.S. Cl. CPC F17C 5/02; F17C 13/001; F17C 2201/0119; F17C 2201/032; F17C 2203/0391; F17C 2225/0161; F17C 2205/0161; F17C 2205/0329; F17C 2205/0394; F17C 2221/014; F17C 2223/0161; F17C 2203/0643

(57) ABSTRACT

A storage tank for cryogenic liquid having an outer tank constructed of a rigid material and an inner tank contained within and spaced inwardly from the outer tank. A first fill line for cryogenic liquid has a first end open exteriorly of the outer tank and a second end open inside the inner tank. The first fill line is fluidly sealed to both the inner tank and the outer tank and the first fill line has a first predetermined flow rate at a set filling pressure. A valve is associated with the first fill line to selectively open and close the first fill line. A second fill line for cryogenic liquid has a first end open exteriorly of the outer tank and a second end open inside of the inner tank. The second fill line has a second predetermined flow rate at the predetermined filling pressure. Furthermore, the first and second lines are sized so that the first flow rate is several times the second flow rate.

### BACKGROUND OF THE INVENTION

### I. Field of the Invention

The present invention relates generally to storage tanks for cryogenic liquid.

### II. Description of Related Art

Cryogenic liquids, for example liquid nitrogen, are used for a number of different purposes. For example, cryogenic liquid is oftentimes used to store biological specimens such as sperm, human and animal tissue, and the like.

For example, oftentimes storage facilities containing one or several cryogenic freezers are employed to store biological specimens in hospitals, laboratories, and other research facilities. It is well known that such biological specimens may be stored at cryogenic temperatures for long periods of time without degradation.

The cryogenic freezers used to store the biological specimens are highly thermally insulated in order to maintain the cryogenic temperatures within the interior of the freezer. However, some loss of the cryogenic temperatures occurs not only through natural thermal conduction, but also whenever the cryogenic freezer is opened for either the removal or insertion of the biological specimens.

Consequently, all cryogenic freezers experience some heat gain during the normal operation of the freezer. In order to maintain the cryogenic temperature within the interior of the cryogenic freezer, and thus maintain the integrity of the biological specimens, it is necessary to replenish the cryogenic liquid in the cryogenic tanks supplying the cryogenic freezers on a periodic basis.

Typically, the tank containing the cryogenic liquid, usually liquid nitrogen, is refilled on a weekly basis. In order to effect the refilling of the tank, the supply line from the cryogenic tank which is normally coupled to the cryogenic freezer is, instead, fluidly connected to a source of cryogenic liquid. The source of cryogenic liquid then fills the cryogenic tank over a period of time.

One disadvantage of the previously known method of refilling the cryogenic tanks by fluidly connecting their output line for the cryogenic liquid to a source of cryogenic liquid is that the output line from the tank is relatively small diameter, e.g. one quarter of an inch OD. Such a small diameter is more than sufficient for the cryogenic tank to supply the cryogenic liquid to the freezer during the normal operation of the freezer since the flow rate from the cryogenic tank is very small. However, when the cryogenic tank is refilled, the diameter of the output line from the cryogenic tank limits the flow rate of the cryogenic liquid from the refill source to the cryogenic tank so that the refilling time for the cryogenic tank may take up to one hour.

Many cryogenic storage facilities, contain many cryogenic freezers, each having their own tank or source of cryogenic liquid. Consequently, refilling all of the tanks of cryogenic liquid at the cryogenic facility may take several days to accomplish. Furthermore, the limiting factor for the refilling time of the cryogenic tanks results from the small diameter of the cryogenic output line, which is also the input line during a filling operation, of the cryogenic liquid for the tanks.

### SUMMARY OF THE PRESENT INVENTION

The present invention provides a storage tank for cryogenic liquid which overcomes the above-mentioned disadvantages of the previously known cryogenic tanks.

In brief, the storage tank includes an outer tank constructed of a rigid material such as stainless steel. An inner tank is contained within and spaced inwardly from the outer tank and the inner tank is also constructed of a rigid material, such as stainless steel. Insulation may be provided within the space between the inner and outer tanks, and the space between the inner and outer tanks is preferably evacuated.

In the conventional manner, the inner tank is adapted to contain a cryogenic liquid, such as liquid nitrogen. Furthermore, conventional valving is fluidly connected to the inner tank to access the cryogenic liquid within the inner tank and provide that cryogenic liquid through a supply line to a cryogenic freezer or other device requiring the cryogenic liquid.

In addition to the supply line, a fill line for cryogenic liquid has its first end open through a valve exteriorly to the outer tank and its inner end open to the interior of the inner tank, preferably adjacent its lower end. This fill line, unlike the supply line, is several times the cross-sectional area of the supply line. As such, the liquid flow rate of the liquid nitrogen that can be maintained through the fill line is much greater than can be maintained through the supply line. This, in turn, allows the entire inner tank to be rapidly filled in contrast to the slower fill time while using the previously known smaller diameter liquid lines for the cryogenic tank.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a front view illustrating a preferred embodiment of the storage tank of the present invention;

FIG. 2 is a longitudinal sectional view thereof; and

FIG. 3 is an elevational sectional view thereof.

### DETAILED DESCRIPTION OF A PREFERRED EMBODIMENT OF THE PRESENT INVENTION

With reference to the drawing, a preferred embodiment of a cryogenic storage tank 10 according to the present invention is shown. The cryogenic storage tank 10 stores cryogenic liquid, such as liquid nitrogen, for many different purposes. One such purpose, for example, is to provide the liquid nitrogen to cryogenic freezers of the type used to store biological specimens.

The cryogenic storage tank 10 includes an outer tank 12 which is generally cylindrical in shape having a closed top 14 and closed bottom 16. The outer tank 12 is typically constructed of stainless steel although other materials may be used without deviation from either the spirit or scope of the invention.

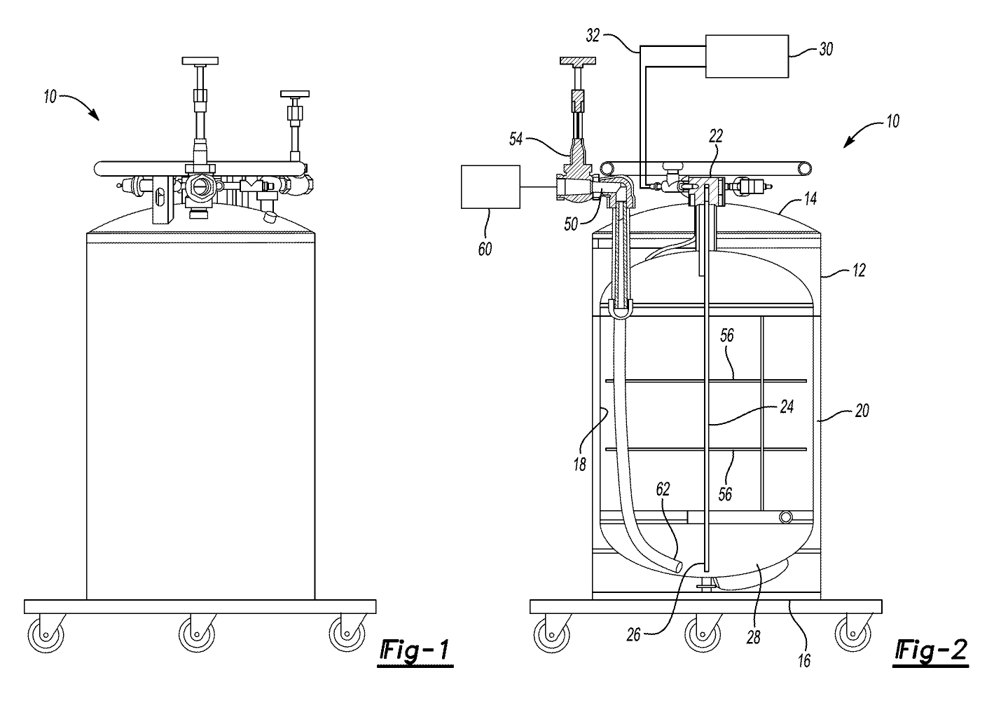

With reference now to FIG. 2, the cryogenic storage tank 10 includes an inner tank 18. The inner tank is completely contained within the interior of the outer tank 12. The inner tank 18 is generally cylindrical in shape and

an inner tank 18 is contained within the interior of the outer tank 12. This inner tank 18 is also preferably made of stainless steel and is spaced inwardly from the outer tank 12. As such, a space 20 is created between the inner tank 18 and the outer tank 12. In the conventional manner, this storage space 20 is typically evacuated and/or filled with a thermal insulating material.

As best shown in FIGS. 1 and 2, a conventional valve assembly 22 is mounted to the top 14 of the outer tank 12. This valve assembly 22, furthermore, is fluidly connected by a fluid line 24 which is open at its lower end 26 adjacent a bottom 28 of the inner tank 18.

The valve assembly 22 is conventional in construction and includes various valves to not only monitor, but also release excess pressure from the interior of the inner tank 18. The valve assembly 22 is also fluidly connected to supply cryogenic liquid to the cryogenic freezer 30, or other cryogenic equipment, by a supply line 32.

In operation, only a small volume of cryogenic liquid from the interior of the inner tank 18 is used to supply the cryogenic equipment 30. As such, only a very small flow rate of the cryogenic liquid from the inner tank 18 is required to operate the cryogenic equipment 30. Consequently, the supply line 32 typically has a very small diameter, e.g. one quarter of an inch.

Although the cryogenic tank 10 may be refilled with the cryogenic liquid by fluidly connecting a source of cryogenic liquid to the valve assembly 22 and ultimately to the small diameter tube 24, the fill time required for the cryogenic tank 18 is very slow. In order to provide a rapid fill for the inner tank 18 of cryogenic liquid, a second fill line 50 has one end which extends outwardly from the top 14 of the cryogenic outer tank 12. The second fill line 50, furthermore, extends through both the outer tank 12 and inner tank 18 and has an inner end 52 adjacent the bottom of the inner tank 18. A conventional fluid valve 54, furthermore, is fluidly connected in series with the second fill line 50 and further provides the benefit of being able to supply and refill the tank concurrently.

The second fill line 50 has an inside diameter greater than the inside diameter of the primary or first fill/supply line 24. As such, the cross sectional area of the interior of the supply line 50 is several times the cross sectional area of the first supply line 24. This greater area, furthermore, allows a much greater flow rate through the second supply line 50 than the first supply line 24 with pressure provided by the refill source 60.

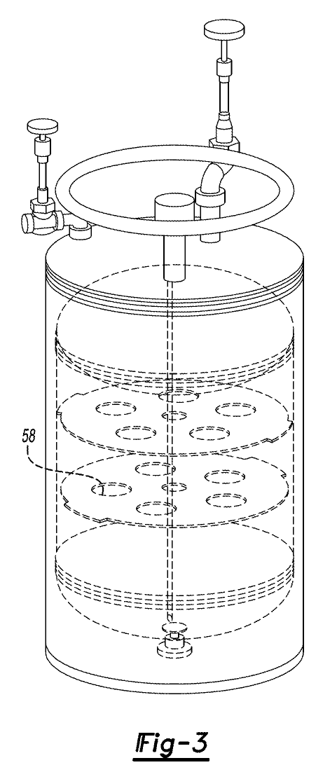

With references no to FIG. 3, the cryogenic storage tank 10 includes baffles 56. The baffles 56 are generally disc shaped and are contained with the inner tank 18

As best shown in FIG. 3, one or more liquid baffles 56 are contained within the interior of the inner tank 18 and are axially spaced from each other. These baffles 56 include through openings 58 to minimize sloshing of the cryogenic liquid during a refill operation.

In operation, when refilling of the cryogenic tank 10 is required, a refill source 60 of cryogenic liquid is first fluidly connected to the second fill line 50. Thereafter, the valve 54 is open and which allows the cryogenic liquid from the refill source 60 to flow through the second refill line 50 and into the interior of the inner tank 18.

Any conventional means, such as valving on the valve assembly 22, may be used to determine when the inner tank 18 is filled. Once this occurs, the valve 54 is closed and the refill source 60 disconnected from the second line 50.

Since the inside diameter of the second refill line 50 is greater, and preferably several times greater than the primary refill/supply line 24, a refilling of the inner tank 18 may be rapidly accomplished in a few minutes.

From the foregoing, it can be seen that the cryogenic storage tank of the present invention provides a storage tank which enables rapid refilling of the storage tank as required. Having described my invention, however, many modifications thereto will become apparent to those skilled in the art to which it pertains without deviation from the spirit of the invention as defined by the scope of the appended claims.

I claim:

1. A storage tank for cryogenic liquid comprising:
an outer tank constructed of a rigid material,
an inner tank contained within and spaced inwardly from said outer tank,
a first fill line for cryogenic liquid having a first end open exteriorly of said outer tank and a second end open inside said inner tank, said first fill line being fluidly sealed to both said inner tank and said outer tank, said first fill line having a first predetermined flow rate at a predetermined filling pressure,
a valve associated with said first fill line to selectively open and close said first fill line,
a second fill line for cryogenic liquid having a first end open exteriorly of said outer tank and a second end open inside said inner tank, said second fill line having a second predetermined flow rate at said first predetermined filling pressure,
wherein said first flow rate is several times said second flow rate.

2. The invention as defined in claim 1 wherein said second end of said first fill tube is positioned adjacent a bottom of said inner tank.

3. The invention as defined in claim 2 and comprising at least one flow baffle contained in said inner tank.

4. The invention as defined in claim 3 and comprising at least two baffles contained in said inner tank.

5. The invention as defined in claim 1 and comprising a valve arrangement to fill and discharge the inner tank through said second fill line.
